(19) United States
(12) Patent Application Publication
(10) Pub. No.: US 2026/0351046 A1
(43) Pub. Date: Nov. 5, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Minato-ku, Tokyo (JP)

(72) Inventors: Takahiro TOIZUMI, Tokyo (JP); Yuho SHOJI, Tokyo (JP)

(73) Assignee: NEC Corporation, Minato-ku, Tokyo (JP)

(21) Appl. No.: 19/121,216

(22) PCT Filed: Oct. 31, 2022
(86) PCT No.: PCT/JP2022/040735

§ 371 Date: Apr. 15, 2025

(51) Int. Cl. G06V 40/18; G06N 3/084

(52) U.S. Cl. CPC G06V 40/197; G06N 3/084; G06V 40/193

(57) ABSTRACT

An information processing apparatus (10) includes an acquisition unit (110), a detection unit (130), and a loss computation unit (150). The acquisition unit (110) acquires a target image and ground truth feature information. The detection unit (130) detects estimated feature information relating to a detection target from the target image by using a detection model. The loss computation unit (150) computes a loss L for updating a parameter of the detection model in such a way as to generate a detection model capable of tolerating a deviation of the estimated feature information from the ground truth feature information.

### TECHNICAL FIELD

The present disclosure relates to an information processing apparatus, an information processing method, and a medium.

### BACKGROUND ART

A machine learning model for detecting a predetermined area in an image is proposed.

Patent Document 1 describes detecting a facial landmark by using a machine learning model for pose estimation. As an example, Patent Document 1 describes detecting a plurality of eye landmarks close to an eyebrow in order to extract an eye area from a face image.

Patent Document 2 describes an iris extraction apparatus that extracts an iris part of an eye image. Further, Patent Document 2 describes that the iris extraction apparatus can be implemented by using a deep neural network.

Patent Document 3 describes learning of a model for detecting a feature figure and a keypoint from an image. Specifically, Patent Document 3 describes that learning is executed by comparing ground truth data of a feature figure and a keypoint with a detected feature figure and a detected keypoint.

### RELATED DOCUMENTS

### Patent Documents

Patent Document 1: Japanese Patent Application Publication No. 2022-39984
Patent Document 2: Japanese Patent Application Publication No. 2022-44603
Patent Document 3: International Patent Publication No. WO 2022/059066

### SUMMARY

### Technical Problem

An object of the disclosure is to improve techniques described in Related Documents

### Solution to Problem

According to one aspect of the present disclosure, provided is an information processing apparatus including:
an acquisition unit that acquires a target image and ground truth feature information;
a detection unit that detects estimated feature information relating to a detection target from the target image by using a detection model; and
a loss computation unit that computes a loss for updating a parameter of the detection model in such a way as to generate a detection model capable of tolerating a deviation of the estimated feature information from the ground truth feature information.

According to one aspect of the present disclosure, provided is an information processing method including,
by one or more computers:
   acquiring a target image and ground truth feature information;
   detecting estimated feature information relating to a detection target from the target image by using a detection model; and
   computing a loss for updating a parameter of the detection model in such a way as to generate a detection model capable of tolerating a deviation of the estimated feature information from the ground truth feature information.

According to one aspect of the present disclosure, provided is a computer-readable medium storing a program,
the program causing a computer to function as:
   an acquisition unit that acquires a target image and ground truth feature information;
   a detection unit that detects estimated feature information relating to a detection target from the target image by using a detection model; and
   a loss computation unit that computes a loss for updating a parameter of the detection model in such a way as to generate a detection model capable of tolerating a deviation of the estimated feature information from the ground truth feature information.

### BRIEF DESCRIPTION OF THE DRAWINGS

FIG. 1 It is a diagram illustrating an overview of an information processing apparatus according to a first example embodiment.

FIG. 2 It is a diagram illustrating an overview of an information processing method according to the first example embodiment.

FIG. 3 It is a diagram illustrating a function of a detection model according to the first example embodiment.

FIG. 4 It is a diagram illustrating a target image and feature information.

FIG. 5 It is a block diagram illustrating a function configuration of the information processing apparatus according to the first example embodiment.

FIG. 6 It is a flowchart illustrating a flow of processing executed by the information processing apparatus according to the first example embodiment.

FIG. 7 It is a flowchart illustrating a flow of processing performed by a loss computation unit according to the first example embodiment.

FIG. 8 It is a diagram illustrating a relationship between a distance d and a loss L according to the first example embodiment.

FIG. 9 It is a diagram illustrating a computer for achieving the information processing apparatus.

FIG. 10 It is a flowchart illustrating a flow of processing executed by an information processing apparatus according to a modified example 1.

FIG. 11 (a) to (c) are diagrams for describing an error of ground truth feature information.

FIG. 12 It is a flowchart illustrating a flow of processing performed by a loss computation unit according to a second example embodiment.

FIG. 13 It is a diagram illustrating a first example of a relationship between a distance d and a loss L according to a third example embodiment.

FIG. 14 It is a diagram illustrating a second example of a relationship between a distance d and a loss L according to the third example embodiment.

FIG. 15 It is a block diagram illustrating a function configuration of an information processing apparatus according to a fourth example embodiment.

FIG. 16 It is a flowchart illustrating a flow of processing executed by a feature extraction unit and a loss computation unit according to the fourth example embodiment in a case where a distance d is less than a reference value ε.

FIG. 17 It is a flowchart illustrating a flow of processing executed by a loss computation unit according to a fifth example embodiment.

FIG. 18 It is a diagram illustrating a function g(x).

FIG. 19 It is a diagram illustrating a function g(d−ε) .

FIG. 20 It is a block diagram illustrating a function configuration of an information processing apparatus according to a sixth example embodiment.

FIG. 21 It is a diagram for describing an authentication unit.

FIG. 22 It is a diagram illustrating a function configuration of an authentication apparatus according to a seventh example embodiment.

FIG. 23 It is a flowchart illustrating a flow of processing performed by the authentication apparatus according to the seventh example embodiment.

### EXAMPLE EMBODIMENT

Hereinafter, example embodiments of the present disclosure will be described by using the drawings. Note that, a similar component is assigned with a similar reference sign throughout all the drawings, and description therefor will be omitted as appropriate.

### Example Embodiment 1

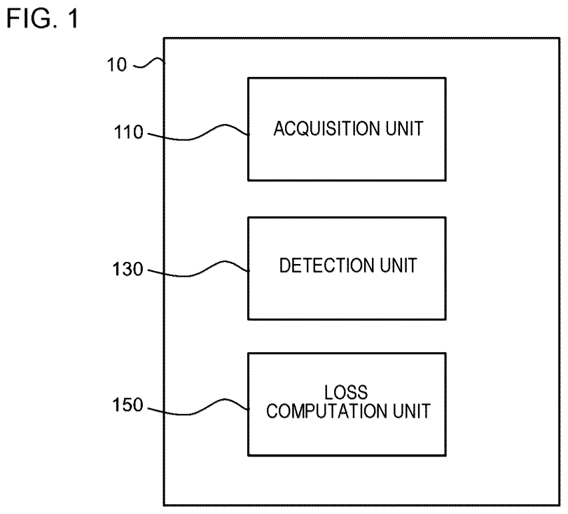

FIG. 1 is a diagram illustrating an overview of an information processing apparatus 10 according to a first example embodiment. The information processing apparatus 10 according to the present example embodiment includes an acquisition unit 110, a detection unit 130, and a loss computation unit 150. The acquisition unit 110 acquires a target image and ground truth feature information. The detection unit 130 detects estimated feature information relating to a detection target from the target image by using a detection model. The loss computation unit 150 computes a loss L for updating a parameter of the detection model in such a way as to generate a detection model capable of tolerating a deviation of the estimated feature information from the ground truth feature information.

According to the information processing apparatus 10, highly effective detection is achieved even in a case where ground truth feature information includes an error.

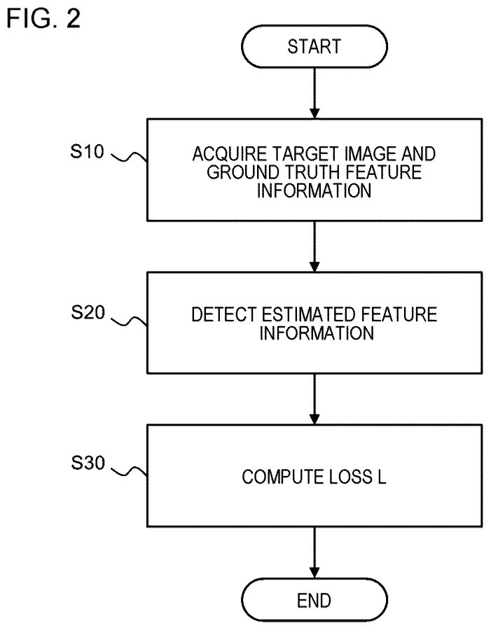

FIG. 2 is a diagram illustrating an overview of an information processing method according to the present example embodiment. The information processing method according to the present example embodiment is executed by one or more computers. The information processing method according to the present example embodiment includes Steps S10 to S30. In Step S10, a target image and ground truth feature information are acquired. In Step S20, estimated feature information relating to a detection target is detected from the target image by using a detection model. In Step S30, a loss L for updating a parameter of the detection model in such a way as to generate a detection model capable of tolerating a deviation of the estimated feature information from the ground truth feature information is computed.

According to the information processing method, highly effective detection is achieved even in a case where ground truth feature information includes an error.

The information processing method can be executed by the information processing apparatus 10 according to the present example embodiment.

Hereinafter, a detailed example of the information processing apparatus 10 according to the present example embodiment and the information processing method according to the present example embodiment will be described.

Machine learning of a detection model is performed by using ground truth data. However, ground truth data may have an error. For example, a person may manually attach a figure or a point related to an area to be detected in an image and use the figure or the point as ground truth data. Such a human operation may cause an error in the ground truth data. Further, a degree of error that can be tolerated in detection performance of a detection model differs according to a purpose of using the detection model. That is, trying to accurately match an output result of a detection model with ground truth data through machine learning may not always be effective in light of a purpose of using the detection model.

In the technique described in Patent Documents 1 to 3, no consideration is given to an error that may be included in a ground truth.

According to the information processing apparatus 10 according to the present example embodiment, the loss computation unit 150 computes a loss L for updating a parameter of a detection model in such a way as to generate a detection model capable of tolerating a deviation of estimated feature information from ground truth feature information. Accordingly, through machine learning in consideration of influence of an error that may be included in ground truth feature information, highly effective detection is achieved in light of a purpose of the detection model. Note that, a loss L in machine learning is a value based on magnitude of discrepancy between a ground truth and a prediction result output by a detection model. In machine learning, a parameter of a model is updated in such a way as to minimize a value of a loss L.

### <Target Image and Feature Information>

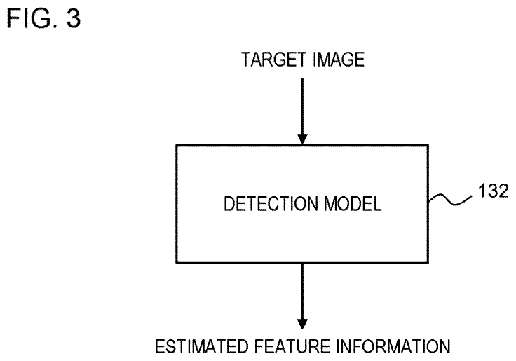

FIG. 3 is a diagram illustrating a function of a detection model 132 according to the present example embodiment. The information processing apparatus 10 is an apparatus that performs machine learning of the detection model 132. The detection model 132 includes a neural network. The detection model 132 is a model for detecting feature information relating to a detection target from a target image. The feature information detected by the detection model 132 is also referred to particularly as “estimated feature information”. On the other hand, the feature information included as a ground truth in training data for machine learning is also referred to particularly as “ground truth feature information”. The “estimated feature information” and the “ground truth feature information” are collectively referred to simply as “feature information”.

Input data of the detection model 132 include a target image. Output data of the detection model 132 include estimated feature information. The feature information is, for example, information for indicating an area to be detected (hereinafter, referred to as a “target area”) in a target image. In other words, a target area in a target image can be determined by using the feature information.

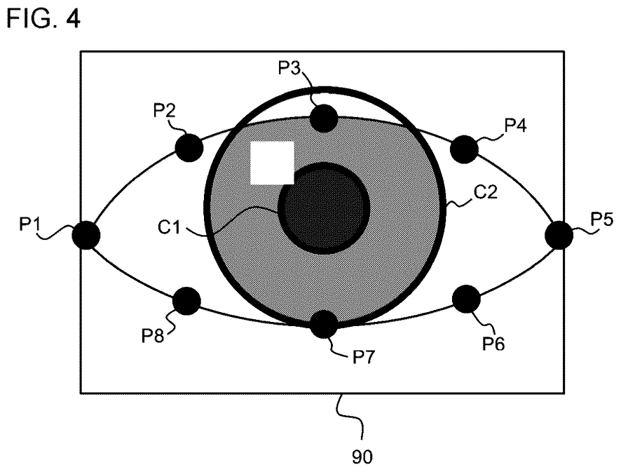

FIG. 4 is a diagram illustrating a target image 90 and feature information. In the example in FIG. 4, the target image 90 is, for example, an image that can be used for iris recognition. In this case, the target image 90 is an image including an eye. The target image 90 may be an image including both eyes, or may be an image including only one of a right eye and a left eye. Further, the target image 90 may be an image including not only an eye, but also a periphery of the eye. The eye included in the target image 90 is, for example, a human eye, but may be an eye of a creature other than a human.

In the example in FIG. 4, the detection target is, for example, an iris. The feature information is, for example, information indicating one or more of figures including a point, a circle, an ellipse, and a combination thereof. However, the feature information may indicate a partially missing circle (or an ellipse) or a partially hidden circle (or an ellipse) in an image as a circle (or an ellipse). In a case where the feature information indicates a figure, the figure indicated by the feature information may be any figure without limitation to a point, a circle, an ellipse, or the like. In the example in FIG. 4, the feature information indicates a circle C1, a circle C2, and points P1 to P8. The circle C1 is relevant to an outer edge of a pupil, and the circle C2 is relevant to an outer edge of an iris. The points P1 to P8 are relevant to a plurality of points located on an edge of an eyelid. An iris area in the target image 90 can be determined by the circles and the points.

The circle C1 and the circle C2 are each indicated by center coordinates and a radius (that is, three elements) of the circle. However, the center coordinates of the circle C1 and the center coordinates of the circle C2 may be common. The points P1 to P8 are each represented by coordinates (that is, two elements). The feature information may be a vector including the elements. The vector is referred to as a feature vector. For example, in the example in FIG. 4, the feature information can be represented by a feature vector with twenty-two elements by combining two circles each represented by three elements with eight points each represented by two elements.

Note that, the target image 90 is not limited to an image that can be used for iris recognition. For example, the target image 90 may be an image that can be used for face recognition. In the case, the target image 90 is an image including a face, and the detection model 132 detects a keypoint indicating a location of an eye, a nose, a mouth, or the like in the face as the feature information.

Other than the above, the target image 90 may be an image including an object other than a creature. In the case, the feature information is information indicating a particular area of the object.

### <Flow of Processing>

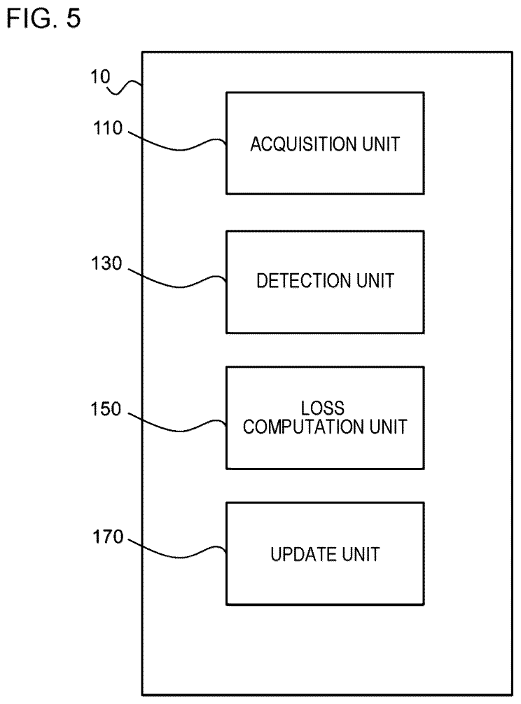

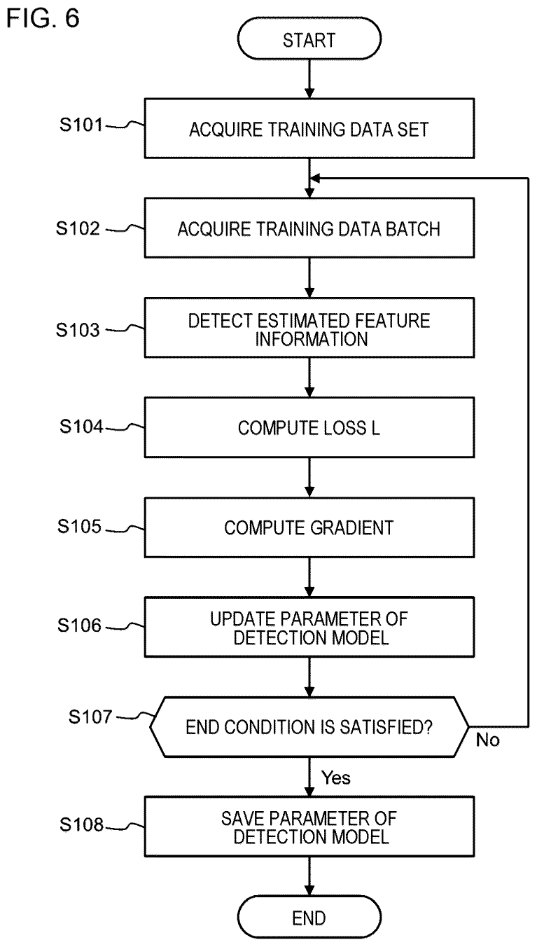

FIG. 5 is a block diagram illustrating a function configuration of the information processing apparatus 10 according to the present example embodiment. In the example in the present figure, the information processing apparatus 10 further includes an update unit 170. FIG. 6 is a flowchart illustrating a flow of processing executed by the information processing apparatus 10 according to the present example embodiment. The function configuration units of the information processing apparatus 10 will be described below in detail with reference to FIGS. 5 and 6.

The acquisition unit 110 acquires the target image 90 and ground truth feature information. The ground truth feature information is feature information as a ground truth relevant to the target image 90. A combination of the target image 90 and the ground truth feature information relevant to the target image 90 is referred to as training data. The ground truth feature information is prepared in advance, for example, by specifying, for the target image 90, one or more of figures including a point, a circle, an ellipse, and a combination thereof for determining a target area. The specification is performed, for example, by a person performing such an operation of drawing a point or a figure in a superimposed way (that is, performing annotation) on the target image 90 displayed on a display. However, the ground truth feature information may be prepared by another method.

Herein, the ground truth feature information may include an error. That is, the ground truth feature information does not need to be completely correct. The ground truth feature information may be used as a target in machine learning.

For example, a storage unit that can be accessed from the acquisition unit 110 holds a plurality of pieces of training data prepared in advance. The target images 90 included in the plurality of pieces of training data are different from each other. The sizes of detection targets in the plurality of target images 90 may be different from each other, but preferably are the same as each other. The acquisition unit 110 reads and acquires training data from the storage unit. Note that, the acquisition unit 110 may acquire training data from another apparatus instead of reading training data from the storage unit.

In the example illustrated in FIG. 6, in Step S101, the acquisition unit 110 acquires and holds a training data set including a plurality of pieces of training data. Furthermore, in Step S102, the acquisition unit 110 acquires two or more pieces of training data of the training data set as a training data batch. In this way, the information processing apparatus 10 performs machine learning by dividing the training data set into a plurality of data batches. That is, the information processing apparatus 10 updates a parameter of the detection model 132 for each training data batch. The number of pieces of training data included in a training data batch can be defined in advance. However, the number of pieces of training data included in a training data batch may not always be constant. By updating a parameter of the detection model 132 for each training data batch, accuracy of updating each parameter can be improved.

Next, in Step S103, the detection unit 130 detects estimated feature information in each of the plurality of target images 90 included in the training data batch.

The detection unit 130 detects estimated feature information from each of the target images 90 by using the detection model 132. Specifically, the detection unit 130 inputs, to the detection model 132, one target image 90 included in the training data batch acquired by the acquisition unit 110. Then, estimated feature information relevant to the input target image 90 is output from the detection model 132. The output estimated feature information is associated with the input target image 90, that is, the target image 90 from which the estimated feature information is detected. The output estimated feature information may be associated with training data including the target image 90 from which the estimated feature information is detected. The detection unit 130 acquires estimated feature information for all the target images 90 included in the training data batch by sequentially inputting the plurality of target images 90 to the detection model 132.

Next, in Step S104, the loss computation unit 150 computes a loss L by using the estimated feature information and the ground truth feature information. One loss L is computed for each training data batch. A method of computing a loss L by the loss computation unit 150 will be described later in detail.

The update unit 170 updates, by using the loss L, a parameter of the detection model 132 for use by the detection unit 130. The update unit 170 updates a parameter of the detection model 132, for example, by an error back-propagation method using the loss L. In this way, accuracy of detecting a detection target by the detection model 132 can be improved.

In Step S105 in FIG. 6, the update unit 170 computes a gradient for each parameter of the detection model 132 by using the loss L. In Step S106, the update unit 170 updates each parameter of the detection model 132, based on the computed gradient and a learning rate set in advance. Various existing methods can be employed for a method of computing a gradient and a method of updating a parameter by the update unit 170.

In Step S107, whether a condition for ending iteration is satisfied is determined. In a case where the end condition is not satisfied (No in S107), processing returns to Step S102. A series of processing from Steps S102 to S106 is defined as one iteration of a learning loop, and repeating the series of processing over and over advances learning of the detection model 132. In a case where the end condition is satisfied (Yes in S107), the parameter of the detection model 132 at the point of time is saved in Step S108, and the learning ends. Note that, the learned parameter of the detection model 132 may be saved in a middle of learning.

The end condition may be a condition that the number of iterations becomes a predetermined number, or may be a condition that a rate of change of the loss L computed in Step S104 with respect to the number of iterations becomes equal to or less than a predetermined value. Alternatively, the end condition may be that at least one of the conditions is satisfied.

### <Method of Computing Loss L>

A method of computing a loss L by the loss computation unit 150 will be described below in detail.

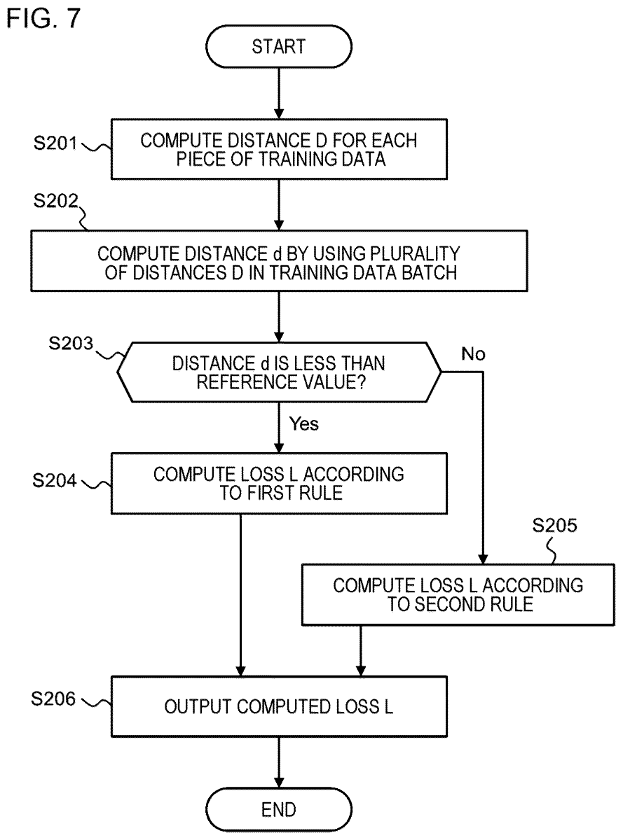

FIG. 7 is a flowchart illustrating a flow of processing performed by the loss computation unit 150 according to the present example embodiment. The loss computation unit 150 computes a distance D for each piece of training data in Step S201. The distance D is a distance between estimated feature information and ground truth feature information relevant to the estimated feature information. That is, in a case where estimated feature information is detected in a certain target image 90, the distance D is computed by using ground truth feature information included in the same training data as the target image 90 and the detected estimated feature information.

For example, feature information includes a feature vector, as described above. The feature vector included in ground truth feature information is hereinafter referred to as a “ground truth feature vector ka”, and the feature vector included in estimated feature information is hereinafter referred to as an “estimated feature vector kₚ”. Then, the loss computation unit 150 computes a distance D between the ground truth feature vector kₐ and the estimated feature vector kₚ. The distance D is acquired, for example, by using a following equation (1). Herein, ∥·∥ₙ represents an Lⁿ norm, and n is, for example, 1. However, n is not particularly limited, and may be a value satisfying 1≤n<∞.

D=∥kₚ−kₐ∥ₙ (1)

After the distances D are computed for all pieces of training data included in a training data batch to be processed, the loss computation unit 150 computes a distance d, based on the plurality of distances D in Step S202. Specifically, the loss computation unit 150 computes a sum or an average of the plurality of distances D as a distance d.

The loss computation unit 150 computes a loss L as follows, by using the thus acquired distance d. That is, the loss computation unit 150 determines whether the distance d is less than a predetermined reference value ε in Step S203.

In a case where the distance d is less than the predetermined reference value ε (Yes in Step S203), the loss computation unit 150 computes a loss L, based on a first rule (Step S204). On the other hand, in a case where the distance d is equal to or more than the reference value (No in Step S203), the loss computation unit 150 computes a loss L, based on a second rule different from the first rule (Step S205). In this way, the loss L can be computed more appropriately. Further, even in a case where ground truth feature information includes an error, influence of the error in learning can be minimized.

The first rule and the second rule each are not limited, but the loss L acquired in the first rule preferably increases monotonically or is constant with respect to the distance d. The loss L acquired in the second rule preferably increases monotonically with respect to the distance d.

A relationship between the first rule and the second rule is not limited, but any loss L computed in the first rule is preferably smaller than any loss L computed in the second rule. Further, any slope of the loss L acquired in the first rule with respect to the distance d is preferably smaller than any slope of the loss L acquired in the second rule with respect to the distance d.

For example, the first rule is a first mathematical equation L=f₁(d) for substituting the distance d to acquire the loss L, and the second rule is a second mathematical equation L=f₂(d) for substituting the distance d to acquire the loss L. Herein, f₁(d)<f₂(d) preferably holds for all the distances d less than the reference value ε. The loss L is then computed based on the first rule in a case where the distance d is less than the reference value ε, as described above. By doing so, the loss L computed in a case where the distance d is small can be minimized compared to a case where the loss L is computed by using the second mathematical equation L=f₂(d) for all d. According to such a loss L, it is less likely to update a parameter in such a way as to bring estimated feature information closer to ground truth feature information than is necessary.

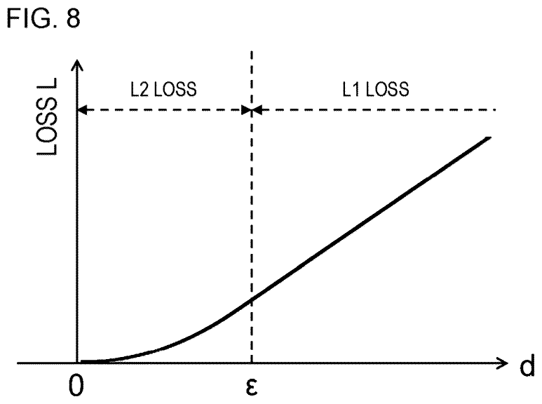

FIG. 8 is a diagram illustrating a relationship between the distance d and the loss L according to the present example embodiment. In the example in FIG. 8, the loss computation unit 150 computes an L2 loss as the loss L in a case where the distance d is less than the reference value ε, and computes an L1 loss as the loss L in a case where the distance d is equal to or more than the reference value ε. That is, the first rule is to use the L2 loss as the loss L, and the second rule is to use the L1 loss as the loss L. The loss L may be a so-called Huber loss.

Even in a case where ground truth feature information includes an error, influence of the error in learning can be minimized by the loss computation unit 150 computing the L2 loss as the loss L in a case where the distance d is less than the reference value ε, and computing the L1 loss as the loss L in a case where the distance d is equal to or more than the reference value ε.

In the example in FIG. 8, it can be also said that the first rule is to compute the loss L by using a quadratic function of the distance d as in a following equation (2), and the second rule is to compute the loss L by using a linear function of the distance d as in a following equation (3). Herein, a₂, a₁, and b₁ each are predetermined real numbers. However, a₂ and a₁ are not zero.

L2 loss=a₂×d² (2)

L1 loss=a₁×d+b₁ (3)

The reference value ε may be defined in advance, or may be determined by the information processing apparatus 10, as will be described in a sixth example embodiment.

In a case of defining the reference value ε in advance, the reference value ε can be defined based on accuracy or the like required for the detection model 132 in light of a purpose of using the detection model 132. Alternatively, the reference value ε may be defined based on a degree of variation of feature information assigned by a plurality of persons to the same target image 90 (annotation), or the reference value ε may be defined based on a degree of variation of feature information assigned to different target images 90. In this case, the reference value ε is preferably defined by increasing importance of the variation for the target image 90 on which influence of an error is large. For example, in a case where the target image 90 is an image that can be used for iris recognition, the reference value ε is preferably defined by increasing importance of the variation for the target image 90 with a small iris diameter.

As illustrated in FIG. 8, change of the loss L with respect to change of the distance d is preferably continuous at the reference value ε. That is, a graph with one axis as an axis of the distance d and another axis as an axis of the loss L is preferably continuous at the reference value ε. In this way, more appropriate learning can be performed. Furthermore, the loss L is preferably differentiable with d at d=value ε .

The mathematical equations for computing the L1 loss and the L2 loss may be defined in advance. However, in a case where the reference value ε is determined by the information processing apparatus 10, at least any of a slope a₁, an intercept b₁ of the linear function for computing the L1 loss, and a coefficient a₂ of the quadratic function for computing the L2 loss may be determined based on the reference value ε by the loss computation unit 150. At this time, the loss computation unit 150 determines, for example, at least any of the slope a₁, the intercept b₁, and the coefficient a₂ in such a way that change of the loss L with respect to change of the distance dis continuous at the reference value ε.

After the loss L is computed in Step S204 or S205, the loss computation unit 150 outputs the loss L in Step S206.

### <Hardware Configuration>

A hardware configuration of the information processing apparatus 10 will be described below. The function configuration units (the acquisition unit 110, the detection unit 130, the loss computation unit 150, and the update unit 170) of the information processing apparatus 10 may be achieved by hardware (example: a hard-wired electronic circuit or the like) achieving the function configuration units, or may be achieved by a combination of hardware and software (example: a combination of an electronic circuit and a program controlling the same or the like). Hereinafter, a case where the function configuration units of the information processing apparatus 10 are achieved by a combination of hardware and software will be further described.

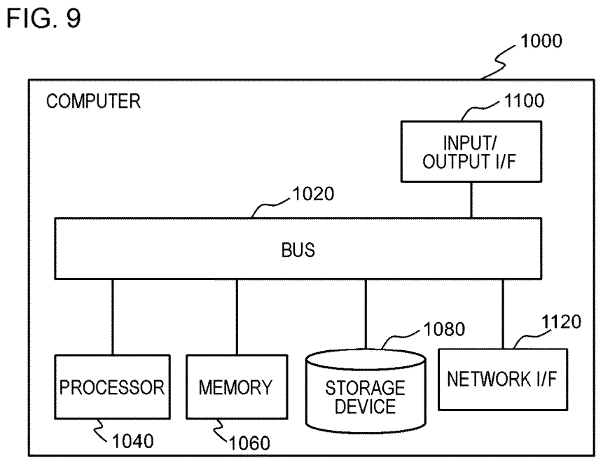

FIG. 9 is a diagram illustrating a computer 1000 for achieving the information processing apparatus 10. The computer 1000 is any computer. For example, the computer 1000 is a system-on-chip (SoC), a personal computer (PC), a server machine, a tablet terminal, a smartphone, or the like. The computer 1000 may be a dedicated computer designed for achieving the information processing apparatus 10, or may be a general-purpose computer. Further, the information processing apparatus 10 may be achieved by one computer 1000, or may be achieved by a combination of a plurality of computers 1000.

The computer 1000 includes a bus 1020, a processor 1040, a memory 1060, a storage device 1080, an input/output interface 1100, and a network interface 1120. The bus 1020 is a data transmission path through which the processor 1040, the memory 1060, the storage device 1080, the input/output interface 1100, and the network interface 1120 transmit and receive data to and from one another. However, a method of connecting the processor 1040 and the like with one another is not limited to bus connection. The processor 1040 is a variety of processors such as a central processing unit (CPU), a graphics processing unit (GPU), or a field-programmable gate array (FPGA). The memory 1060 is a main storage apparatus achieved by using a random access memory (RAM) or the like. The storage device 1080 is an auxiliary storage apparatus achieved by using a hard disk, a solid state drive (SSD), a memory card, a read only memory (ROM), or the like.

The input/output interface 1100 is an interface for connecting the computer 1000 with an input/output device. For example, an input apparatus such as a keyboard or an output apparatus such as a display is connected to the input/output interface 1100. A method of connecting the input/output interface 1100 to an input apparatus or an output apparatus may be wireless connection, or may be wired connection.

The network interface 1120 is an interface for connecting the computer 1000 to a network. The communication network is, for example, a local area network (LAN) or a wide area network (WAN). A method of connecting the network interface 1120 to a network may be wireless connection, or may be wired connection.

The storage device 1080 stores program modules for achieving the function configuration units of the information processing apparatus 10. The processor 1040 achieves functions relevant to the program modules by reading each of the program modules into the memory 1060 and executing the program module.

According to the present example embodiment as described above, the loss computation unit 150 computes a loss L for updating a parameter of a detection model in such a way as to generate a detection model capable of tolerating a deviation of estimated feature information from ground truth feature information. Accordingly, highly effective detection is achieved even in a case where ground truth feature information includes an error.

### Modified Example 1

A modified example 1 is a modified example of the first example embodiment. An information processing apparatus 10 according to the present modified example is the same as the information processing apparatus 10 according to the first example embodiment except for points described below. An information processing method according to the present modified example is the same as the information processing method according to the first example embodiment except for points described below.

In the first example embodiment, a configuration in which the acquisition unit 110 acquires, as a training data batch, a plurality of pieces of training data being a set of the target image 90 and ground truth feature information has been described. Then, in the first example embodiment, the loss computation unit 150 computes a distance D for each of the plurality of pieces of sets (training data), and computes a sum or an average of the plurality of distances D as a distance d.

In the present modified example, a distance d and a loss L are computed for each piece of training data. In this case, a parameter of a detection model 132 is updated for each piece of training data.

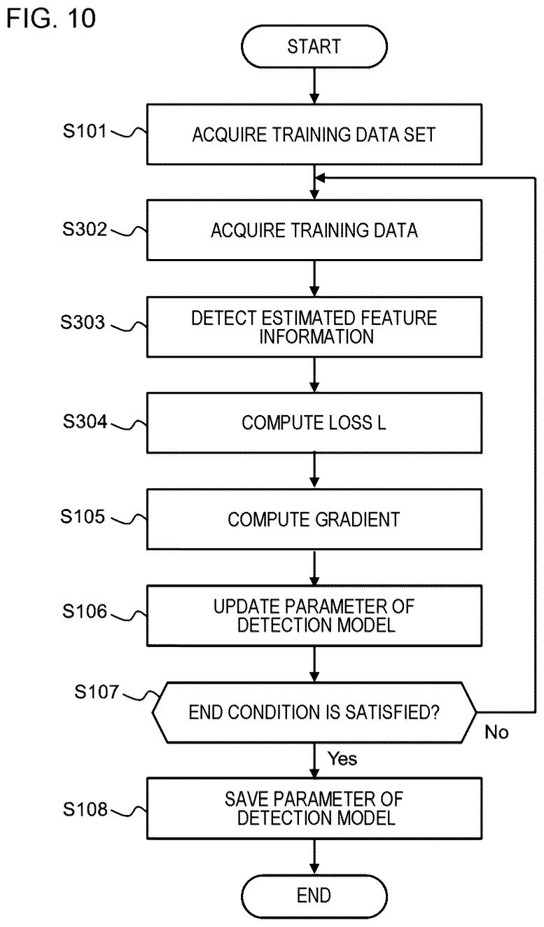

FIG. 10 is a flowchart illustrating a flow of processing executed by the information processing apparatus 10 according to the present modified example. Steps S101 and $105 to S108 in FIG. 10 are the same as Steps S101 and S105 to S108 described in the first example embodiment, respectively.

An acquisition unit 110 according to the present modified example acquires one piece of training data among a training data set in Step S302 following Step S101. Then, in Step S303, a detection unit 130 detects estimated feature information of each of the target images 90 included in the training data. A method of detecting estimated feature information by the detection unit 130 is the same as the method described in the first example embodiment.

In Step S304, a loss computation unit 150 computes a loss L by using the estimated feature information and the ground truth feature information. In the present modified example, one loss L is computed for each piece of training data.

A method of computing a loss L by the loss computation unit 150 will be described below. The loss computation unit 150 computes a distance D between estimated feature information and ground truth feature information relevant to the estimated feature information, in a way similar to Step S201 in FIG. 7. Further, the loss computation unit 150 handles the computed distance D as is as a distance d, and computes a loss L similarly to the first example embodiment.

In Step S105 and thereafter, processing similar to FIG. 6 in the first example embodiment is performed, and a parameter of the detection model 132 is updated and saved.

In the present modified example, an advantageous effect similar to the first example embodiment is acquired.

### Second Example Embodiment

An information processing apparatus 10 according to a second example embodiment is the same as the information processing apparatus 10 according to the first example embodiment except for points described below. An information processing method according to the second example embodiment is the same as the information processing method according to the first example embodiment except for points described below.

In the present example embodiment as well, ground truth feature information includes a ground truth feature vector ka and estimated feature information includes an estimated feature vector kₚ, as described in the first example embodiment. A loss computation unit 150 according to the present example embodiment computes a distance d based on a normalized distance Dₙₒᵣₘ acquired by normalizing a distance between the ground truth feature vector ka and the estimated feature vector kₚ with a size of a detection target. Then, the loss computation unit 150 computes a loss L by using the distance d.

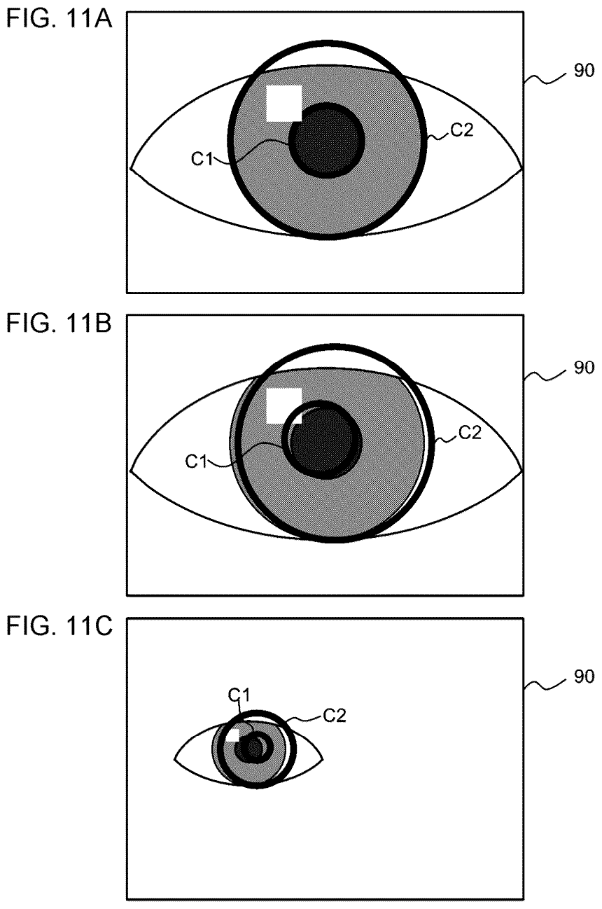

FIG. 11(a) to 11(c) are diagrams for describing an error of ground truth feature information. In a case where a person assigns ground truth feature information to a target image 90, for example, the person performs such an operation of drawing a predetermined figure in a superimposed way on the target image 90. Then, ground truth feature information indicating the drawn figure is generated. In FIG. 11(a) to 11(c), a circle C1 indicating an outer edge of a pupil and a circle C2 indicating an outer edge of an iris are drawn in a superimposed way on the target image 90. In FIG. 11(a), the circle C1 and the circle C2 are well aligned with the outer edges of the pupil and the iris, respectively, and it can be said that there are few errors. On the other hand, In FIG. 11(b) and 11(c), the circle C1 is misaligned with the outer edge of the pupil and the circle C2 is misaligned with the outer edge of the iris. In the example in FIG. 11(b) and 11(c), the ground truth feature information includes an error attributable to the misalignment. Such an error cannot be avoided in a case where a person assigns an annotation as the ground truth feature information.

Herein, FIG. 11(c) includes a smaller detection target (the iris in the present example) in the target image 90 than in FIG. 11(b). Accordingly, even in a case where an amount of misalignment is dimensionally the same between FIG. 11(c) and 11(b), influence of an error on a size of the detection target is larger in FIG. 11(c) than in FIG. 11(b).

In contrast, the loss computation unit 150 according to the present example embodiment computes a distance d based on a normalized distance Dₙₒᵣₘ acquired by normalizing a distance between the ground truth feature vector kₐ and the estimated feature vector kₚ with a size of a detection target. Then, the loss computation unit 150 computes a loss L by using the distance d. Accordingly, even in a case where learning is performed by using a plurality of target images 90 including detection targets of different sizes, the target images 90 can be handled uniformly.

The loss computation unit 150 can compute a normalized distance Dₙₒᵣₘ by using a following equation (4-1) or (4-2). Herein, s is a size of a detection target, and 1<n<∞.

Dₙₒᵣₘ=∥(kₚ−kₐ)/S∥n (4-1)

Dₙₒᵣₘ=∥(kₚ−kₐ)∥n/S (4-2)

The loss computation unit 150 can determine, for example, a size of a detection target by using ground truth feature information. Any of elements in the ground truth feature vector kₐ may indicate a size of a detection target, or the loss computation unit 150 may compute a size of a detection target by using one or more elements.

The size of a detection target may be, for example, a radius, a diameter, or an area of a circle indicated by ground truth feature information, or may be a major diameter, a minor diameter, or an area of an ellipse indicated by ground truth feature information. The size of a detection target may be a length of any side, a radius of a circumscribed circle, a diameter of a circumscribed circle, or an area of a figure indicated by ground truth feature information, or may be a distance between any two points indicated by ground truth feature information. In a case where a detection target is an iris, a size of the detection target is, for example, a radius, a diameter, or an area of a circle indicating an outer edge of the iris.

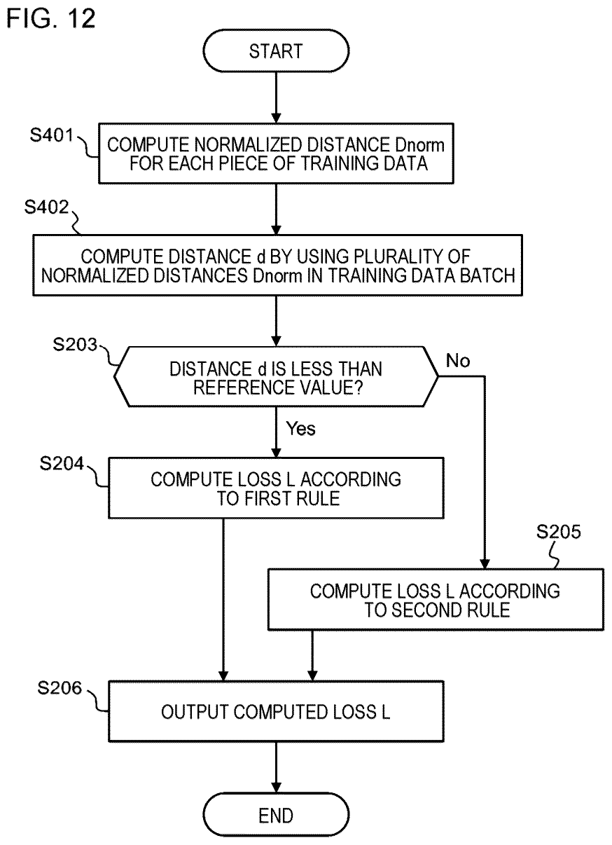

FIG. 12 is a flowchart illustrating a flow of processing performed by the loss computation unit 150 according to the present example embodiment. In the present example embodiment, an acquisition unit 110 acquires, as a training data batch, a plurality of pieces of training data being a set of the target image 90 and ground truth feature information, similarly to the first example embodiment. Then, the loss computation unit 150 computes a normalized distance Dₙₒᵣₘ for each of the plurality of sets (training data) in Step S401. Furthermore, the loss computation unit 150 computes a distance d as a sum or an average of the plurality of normalized distances Dₙₒᵣₘ in Step S402. In this way, by updating a parameter of a detection model 132 for each training data batch, accuracy of updating each parameter can be improved.

The loss computation unit 150 according to the present example embodiment computes a loss L by using the thus computed distance d, with a method similar to the method described in the first example embodiment. Steps S203 to S206 in FIG. 12 are the same as Steps S203 to S206 described in the first example embodiment, respectively.

An update unit 170 according to the present example embodiment updates a parameter of the detection model 132 by using the loss L computed by the loss computation unit 150, with a method similar to the method described in the first example embodiment.

Next, an advantageous effect of the present example embodiment will be described. In the present example embodiment, an advantageous effect similar to the first example embodiment is acquired. In addition, the loss computation unit 150 according to the present example embodiment computes a distance d based on a normalized distance Dₙₒᵣₘ acquired by normalizing a distance between the ground truth feature vector kₐ and the estimated feature vector kₚ with a size of a detection target. Accordingly, even in a case where learning is performed by using a plurality of target images 90 including detection targets of different sizes, the target images 90 can be handled uniformly.

### Modified Example 2

A modified example 2 is a modified example of the second example embodiment. An information processing apparatus 10 according to the present modified example is the same as the information processing apparatus 10 according to the second example embodiment except for points described below. An information processing method according to the present modified example is the same as the information processing method according to the second example embodiment except for points described below.

In the second example embodiment, a configuration in which the acquisition unit 110 acquires, as a training data batch, a plurality of pieces of training data being a set of the target image 90 and ground truth feature information has been described. Then, in the second example embodiment, the loss computation unit 150 computes a normalized distance Dₙₒᵣₘ for each of the plurality of pieces of sets (training data), and computes a sum or an average of the plurality of normalized distances Dₙₒᵣₘ as a distance d.

In the present modified example, a distance d and a loss L are computed for each piece of training data. In this case, a parameter of a detection model 132 is updated for each piece of training data.

A flow of processing executed by the information processing apparatus 10 according to the present modified example is represented by FIG. 10, similarly to the modified example 1. A loss computation unit 150 according to the present modified example computes a normalized distance Dₙₒᵣₘ between estimated feature information and ground truth feature information relevant to the estimated feature information, in a way similar to Step S401 in FIG. 12. Further, the loss computation unit 150 handles the computed normalized distance Dₙₒᵣₘ as is as a distance d, and computes a loss L similarly to the second example embodiment.

Then, processing similar to Step S105 and thereafter in FIG. 6 described in the first example embodiment is performed, and a parameter of the detection model 132 is updated and saved.

In the present modified example, an advantageous effect similar to the second example embodiment is acquired.

### Third Example Embodiment

An information processing apparatus 10 according to a third example embodiment is the same as the information processing apparatus 10 according to any of the first and second example embodiments and the modified examples 1 and 2 except for points described below. An information processing method according to the third example embodiment is the same as the information processing method according to any of the first and second example embodiments and the modified examples 1 and 2 except for points described below.

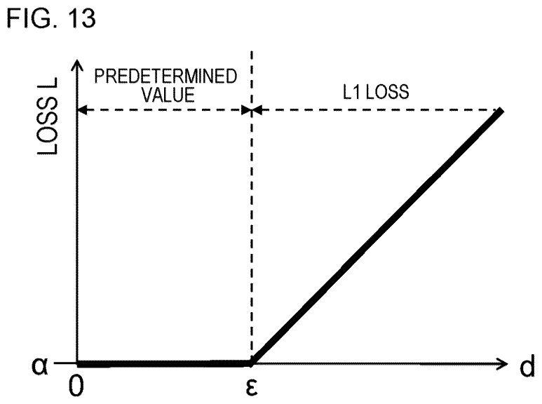

FIG. 13 is a diagram illustrating a first example of a relationship between a distance d and a loss L according to the present example embodiment. A loss computation unit 150 according to the present example embodiment uses a predetermined value α as the loss L in a case where the distance d is less than a reference value ε, and computes an L1 loss as the loss L in a case where the distance d is equal to or more than the reference value ε. That is, a first rule is to use the predetermined value α as the loss L, and the second rule is to use the L1 loss as the loss L. In this way, even in a case where ground truth feature information includes an error, influence of the error in learning can be minimized.

The predetermined value α is defined in advance. The predetermined value α is not particularly limited, but is preferably smaller than any loss L acquired by the distance d equal to or more than the reference value ε. Further, change of the loss L with respect to change of the distance d is preferably continuous at the reference value ε. That is, a graph with one axis as an axis of the distance d and another axis as an axis of the loss L is preferably continuous at the reference value ε.

In the example in FIG. 13, the predetermined value α is zero. In this case, the distance d less than the reference value ε is tolerable in learning of a detection model 132.

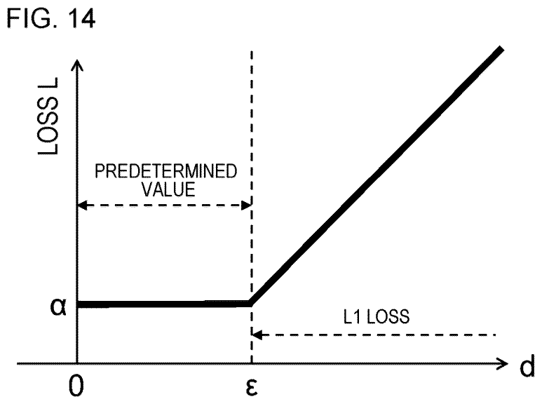

FIG. 14 is a diagram illustrating a second example of a relationship between the distance d and the loss L according to the present example embodiment. In the example in FIG. 14, the predetermined value α is not zero, but is a positive value. However, the predetermined value a is not particularly limited, but may be a positive value, may be a negative value, or may be zero.

The L1 loss is the same as the L1 loss described in the first example embodiment. A mathematical equation for computing the L1 loss by the loss computation unit 150 may be defined in advance. However, in a case where the reference value ε is determined by the information processing apparatus 10, at least any of a slope a₁ and an intercept bi of a linear function for computing the L1 loss may be determined based on the reference value ε by the loss computation unit 150. At this time, the loss computation unit 150 determines, for example, at least any of the slope a₁ and the intercept b₁ in such a way that change of the loss L with respect to change of the distance d is continuous at the reference value ε.

Next, an advantageous effect of the present example embodiment will be described. In the present example embodiment, an advantageous effect similar to the first or second example embodiment is acquired.

### Fourth Example Embodiment

An information processing apparatus 10 according to a fourth example embodiment is the same as the information processing apparatus 10 according to any of the first to third example embodiments and the modified examples 1 and 2 except for points described below.

An information processing method according to the fourth example embodiment is the same as the information processing method according to any of the first to third example embodiments and the modified examples 1 and 2 except for points described below.

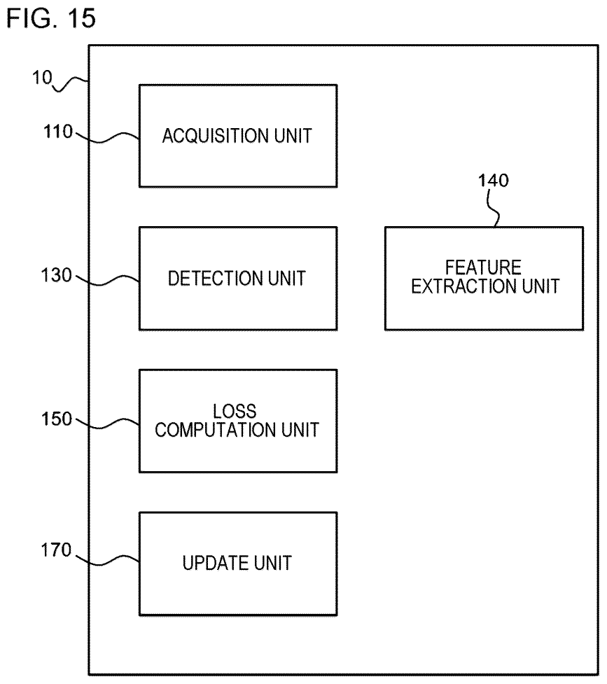

FIG. 15 is a block diagram illustrating a function configuration of the information processing apparatus 10 according to the fourth example embodiment. The information processing apparatus 10 according to the present example embodiment further includes a feature extraction unit 140. The feature extraction unit 140 extracts an estimated target feature vector fₚ indicating a feature of a detection target indicated by estimated feature information. Further, an acquisition unit 110 further acquires a ground truth target feature vector fₐ indicating a feature of a detection target. Then, a loss computation unit 150 according to the present example embodiment computes a loss L by using the estimated target feature vector fₚ and the ground truth target feature vector fₐ in a case where a distance d is less than a reference value ε. On the other hand, the loss computation unit 150 according to the present example embodiment computes an L1 loss based on the estimated feature vector kₚ and the ground truth feature vector kₐ as the loss L in a case where the distance d is equal to or more than the reference value E.

That is, a first rule is to compute the loss L by using the estimated target feature vector fₚ and the ground truth target feature vector fₐ, and a second rule is to use the L1 loss as the loss L. In this way, machine learning of a detection model 132 can be performed in such a way as to improve accuracy of extracting a feature of a detection target.

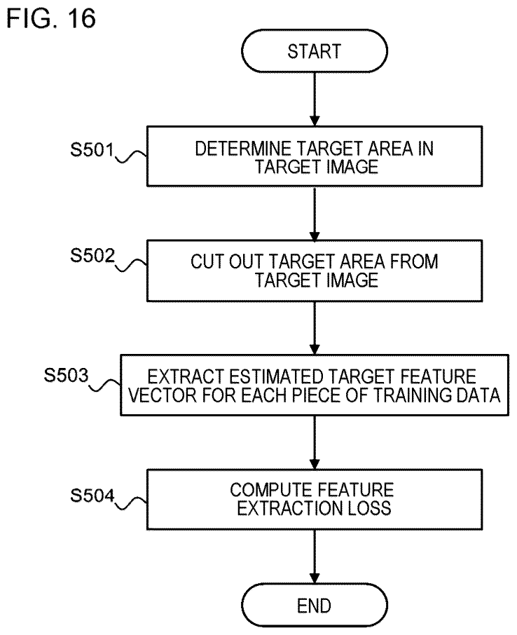

FIG. 16 is a flowchart illustrating a flow of processing executed by the feature extraction unit 140 and the loss computation unit 150 in a case where the distance d is less than the reference value ε. The processing executed by the feature extraction unit 140 and the loss computation unit 150 in a case where the distance d is less than the reference value ε is equivalent to a content of the first rule.

As described in the first example embodiment, a target area in a target image 90 can be determined by using feature information. In Step S501, the feature extraction unit 140 according to the present example embodiment determines a target area in an image by using estimated feature information detected by a detection unit 130.

For example, in a case where the detection target is an iris, the feature extraction unit 140 determines an iris area in the target image 90, based on estimated target information.

Then, the feature extraction unit 140 cuts out the target area from the target image 90 in Step S502, and extracts a feature included in the target area, that is, a feature of the detection target in Step S503. The feature of the detection target is represented by the estimated target feature vector fp. The feature extraction unit 140 can extract the estimated target feature vector fₚ from the image of the target area by using an extraction model including a neural network. The extraction model used herein is preferably a learned model. In a process of learning the detection model 132, a parameter of the neural network of the extraction model may be fixed.

For example, in a case where the detection target is an iris, the feature extraction unit 140 acquires an iris image by cutting out an iris area from the target image 90. Then, the feature extraction unit 140 inputs the iris image to the extraction model, and acquires the estimated target feature vector fₚ indicating a feature (for example, an iris pattern) of the iris as an output of the extraction model.

Then, in Step S504, the loss computation unit 150 computes a feature extraction loss L_{f} by using the estimated target feature vector fₚ extracted by the feature extraction unit 140 and the ground truth target feature vector fₐ. Then, the loss computation unit 150 defines the acquired feature extraction loss L_{f} as the loss L.

The ground truth target feature vector fₐ used for computing the feature extraction loss L_{f} is included in training data, for example, in a state associated with the target image 90. Alternatively, training data may include personal identification information associated with the target image 90. In the case, the personal identification information and the ground truth target feature vector fₐ are held in a state associated with each other in a storage apparatus accessible from the acquisition unit 110. Then, the acquisition unit 110 can read and acquire, from the storage apparatus, the ground truth target feature vector fₐ relevant to the personal identification information included in the training data.

An existing method can be used for a method of computing the feature extraction loss L_{f}. For computation of the feature extraction loss L_{f}, for example, a softmax function and a cross-entropy loss are used. For computation of the feature extraction loss L_{f}, another loss computation approach such as an L2-softmax function, cosface, or arcface may be used.

The feature extraction loss L_{f} is preferably smaller than any loss L acquired by the distance d equal to or more than the reference value ε. Further, change of the loss L with respect to change of the distance d is preferably continuous at the reference value ε. That is, a graph with one axis as an axis of the distance d and another axis as an axis of the loss L is preferably continuous at the reference value ε. A range of the feature extraction loss L_{f} may be set in such a way as to satisfy such conditions.

As described above, the loss computation unit 150 according to the present example embodiment computes an L1 loss based on the estimated feature vector kₚ and the ground truth feature vector kₐ as the loss L in a case where the distance d is equal to or more than the reference value ε. The L1 loss is the same as the L1 loss described in the first example embodiment.

A mathematical equation for computing the L1 loss by the loss computation unit 150 may be defined in advance. However, in a case where the reference value ε is determined by the information processing apparatus 10, at least any of a slope a₁ and an intercept b₁ of a linear function for computing the L1 loss may be determined based on the reference value ε by the loss computation unit 150. At this time, the loss computation unit 150 determines, for example, at least any of the slope a₁ and the intercept b₁ in such a way that change of the loss L with respect to change of the distance d is continuous at the reference value E.

A hardware configuration of a computer achieving the information processing apparatus 10 according to the present example embodiment is represented by, for example, FIG. 9, similarly to the information processing apparatus 10. However, a storage device 1080 of a computer 1000 achieving the information processing apparatus 10 according to the present example embodiment further stores a program module achieving the function of the feature extraction unit 140.

Next, an advantageous effect of the present example embodiment will be described. In the present example embodiment, an advantageous effect similar to at least any of the first to third example embodiments is acquired. In addition, the loss computation unit 150 according to the present example embodiment computes the loss L by using the estimated target feature vector fₚ and the ground truth target feature vector fₐ in a case where the distance d is less than the reference value ε. Accordingly, machine learning of the detection model 132 can be performed in such a way as to improve accuracy of extracting a feature of a detection target.

### Fifth Example Embodiment

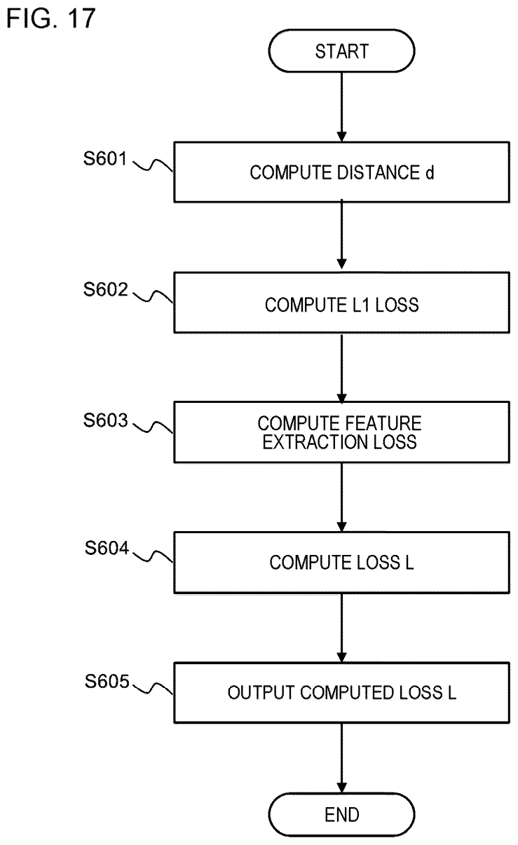

FIG. 17 is a flowchart illustrating a flow of processing executed by a loss computation unit 150 according to a fifth example embodiment. An information processing apparatus 10 according to the present example embodiment is the same as the information processing apparatus 10 according to any of the first to fourth example embodiments and the modified examples 1 and 2 except for points described below. An information processing method according to the present example embodiment is the same as the information processing method according to any of the first to fourth example embodiments and the modified examples 1 and 2 except for points described below.

The information processing apparatus 10 according to the present example embodiment includes a feature extraction unit 140, similarly to the information processing apparatus 10 according to the fourth example embodiment. Further, an acquisition unit 110 acquires a ground truth target feature vector fₐ indicating a feature of a detection target. Then, in the present example embodiment, a loss L computed by the loss computation unit 150 is represented by a following equation (5).

loss L=β×(1 g(d−ε))×E₂+g(d−ε)×E₁ (5)

In the equation (5), β is a predetermined weight, ε is a predetermined reference value ε, and d is a distance d. g(d- 8) is a monotonic increasing function with an output of 0 or more but 1 or less. E₁ is a value computed based on a ground truth feature vector kₐ and an estimated feature vector kₚ, and is, for example, an L1 loss. E₂ is a value computed by using an estimated target feature vector fₚ and a ground truth target feature vector fa. E₂ is, for example, a feature extraction loss L_{f} described in the fourth example embodiment. Description will be given below in detail.

In the present example embodiment, after a detection unit 130 detects estimated feature information of a target image 90, the loss computation unit 150 computes a distance d in Step S601. The distance d and a method of computing the distance d by the loss computation unit 150 are the same as the distance d and the method of computing the distance d by the loss computation unit 150, respectively, described in any of the first and second example embodiments and the modified examples 1 and 2.

Next, the loss computation unit 150 computes an L1 loss in Step S602. The L1 loss and a method of computing the L1 loss by the loss computation unit 150 are the same as the L1 loss and the method of computing the L1 loss by the loss computation unit 150, respectively, described in the first example embodiment.

Next, the loss computation unit 150 computes a feature extraction loss L_{f} in Step S603. The feature extraction loss L_{f} and a method of computing the feature extraction loss L_{f} by the loss computation unit 150 are the same as the feature extraction loss L_{f} and the method of computing the feature extraction loss L_{f} by the loss computation unit 150, respectively, described in the fourth example embodiment. Note that, the loss computation unit 150 may perform Step S603 prior to at least one of S601 and S602.

After the distance d, the L1 loss, and the feature extraction loss L_{f} are computed, the loss computation unit 150 computes a loss L by using the above-described equation (5) in Step S604. Note that, the loss computation unit 150 according to the present example embodiment does not need to perform determination using the reference value ε as in, for example, Step S203 in FIG. 7.

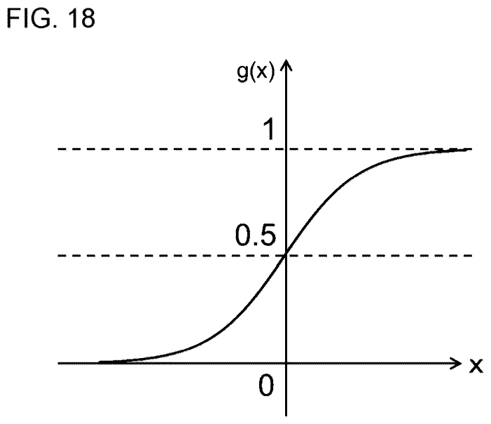

FIG. 18 is a diagram illustrating a function g(x). In the example in FIG. 18, g(x) is a sigmoid function.

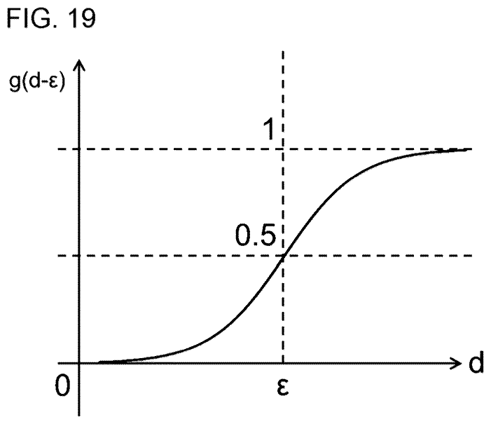

FIG. 19 is a diagram illustrating a function g(d−ε). In the equation (5), a ratio of contribution with respect to the loss L between E₁ and E₂ is changed continuously by using the function g(d−ε). Note that, a so-called temperature parameter indicating spread of the function g(d−ε) can be defined in advance as a part of the function g(d−ε) .

The function g(d−ε) is 0.5 in a case where d=£. That is, E₁ and E₂ contribute equally to the loss L. On the other hand, in a case where d<ε, the function g(d−ε) is smaller than 0.5.

That is, contribution of E₂ to the loss L is larger than contribution of E₁. Then, the smaller d becomes, the smaller contribution of E₁ to the loss L. Further, in a case where d>8, the function g(d−ε) is larger than 0.5. That is, contribution of E₁ to the loss L is larger than contribution of E₂. Then, the larger d becomes, the larger contribution of E₁ to the loss L. In the present example embodiment, change of the loss L with respect to change of the distance dis continuous at the reference value d−ε.

By computing the loss L by using the equation (5), a contribution ratio with respect to the loss L between the L1 loss and the feature extraction loss L_{f}, which are losses in different points of view from each other, can be switched continuously.

Note that, the function g(d−ε) may be a monotonic increasing function with an output of 0 or more but 1 or less, and is not limited to a sigmoid function. Further, E₁ is not limited to the L1 loss as long as the loss is computed based on the ground truth feature vector kₐ and the estimated feature vector kₚ. Further, E₂ is not particularly limited as long as the loss is computed by using the estimated target feature vector fₚ and the ground truth target feature vector fa.

After the loss L is computed, the loss computation unit 150 outputs the computed loss L to an update unit 170 in Step S605.

Next, an advantageous effect of the present example embodiment will be described. In the present example embodiment, an advantageous effect similar to at least any of the first to fourth example embodiments is acquired. In addition, according to present example embodiment, the loss L computed by the detection unit 130 is represented by the above-described equation (5). Accordingly, a contribution ratio with respect to the loss L between the L1 loss and the feature extraction loss L_{f}, which are losses in different points of view from each other, can be switched continuously.

### Sixth Example Embodiment

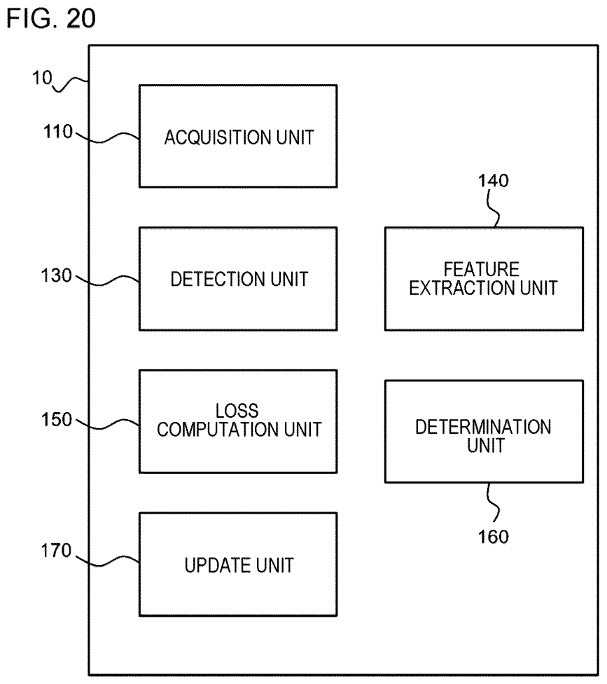

FIG. 20 is a block diagram illustrating a function configuration of an information processing apparatus 10 according to a sixth example embodiment. The information processing apparatus 10 according to the present example embodiment is the same as the information processing apparatus 10 according to any of the first to fifth example embodiments and the modified examples 1 and 2 except for points described below. An information processing method according to the present example embodiment is the same as the information processing method according to any of the first to fifth example embodiments and the modified examples 1 and 2 except for points described below.

The information processing apparatus 10 according to the present example embodiment further includes a determination unit 160. The determination unit 160 determines a reference value ε, based on accuracy required by an authentication unit 20 that performs authentication by using estimated feature information output from a detection model 132.

Note that, while FIG. 20 illustrates an example in which the information processing apparatus 10 includes a feature extraction unit 140, the information processing apparatus 10 may not include the feature extraction unit 140.

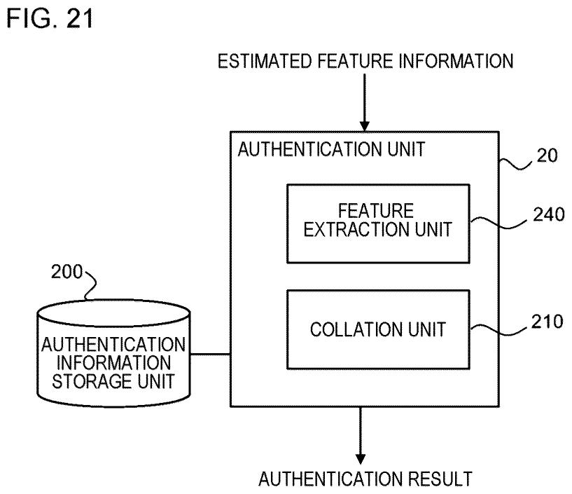

FIG. 21 is a diagram for describing the authentication unit 20. The authentication unit 20 includes a feature extraction unit 240. The feature extraction unit 240 performs processing similar to the feature extraction unit 140. As in the information processing apparatus 10 according to the fourth example embodiment, in a case where the information processing apparatus 10 includes the feature extraction unit 140, the feature extraction unit 240 included in the authentication unit 20 may be the same as the feature extraction unit 140, or may be a feature extraction unit for authentication different from the feature extraction unit 140. The feature extraction unit 240 extracts estimated target feature information indicating a feature of a detection target by using estimated feature information output from a detection unit 130.

The authentication unit 20 further includes a collation unit 210. Further, an authentication information storage unit 200 accessible from the collation unit 210 holds a plurality of sets of identification information (for example, personal identification information) and target feature information. The authentication information storage unit 200 may be included in the authentication unit 20, or may be provided outside the authentication unit 20.

The collation unit 210 computes a degree of agreement between the estimated target feature information extracted by the feature extraction unit 240 and each piece of the target feature information held in the authentication information storage unit 200. Then, the collation unit 210 specifies target feature information for which the degree of agreement satisfies a predetermined condition, and specifies identification information relevant to the specified target feature information, that is, identification information included in the same set as the specified target feature information.

The authentication unit 20 outputs an authentication result. The authentication result output by the authentication unit 20 may be the identification information specified by the collation unit 210, or may be information indicating presence/absence of the target feature information for which the degree of agreement satisfies the predetermined condition.

Herein, accuracy of detecting feature information required by the authentication unit 20 is defined in advance. The detection accuracy can be detection accuracy required by the feature extraction unit 240. Prior to learning of the detection model 132, a user of the information processing apparatus 10 inputs detection accuracy required by the authentication unit 20 to the information processing apparatus 10. Then, the determination unit 160 of the information processing apparatus 10 according to the present example embodiment determines a reference value ε for use in learning, based on the input detection accuracy. Then, the information processing apparatus 10 executes learning of the detection model 132 by using the determined reference value ε.

It can be said that the reference value ε indicates a degree of tolerating a deviation of estimated feature information from ground truth feature information in learning of the detection model 132. That is, the smaller the reference value ε, the smaller a degree of tolerating a deviation of estimated feature information from ground truth feature information. This also means that influence of an error included in ground truth feature information becomes large. Further, the larger the reference value ε, the larger a degree of tolerating a deviation of estimated feature information from ground truth feature information. This also means that influence of an error included in ground truth feature information becomes small. Accordingly, it is important to set the reference value ε appropriately according to a purpose of using the detection model 132.

The determination unit 160 can compute the reference value ε, for example, by using a mathematical equation indicating a relationship between the detection accuracy and the reference value ε. The mathematical equation indicating a relationship between the detection accuracy and the reference value ε is defined in advance.

The mathematical equation indicating a relationship between the detection accuracy and the reference value ε can be determined, for example, based on a relationship between the reference value ε and acquired accuracy of the detection model 132, the relationship being experimentally investigated in advance.

A hardware configuration of a computer achieving the information processing apparatus 10 according to the present example embodiment is represented by, for example, FIG. 9, similarly to the information processing apparatus 10. However, a storage device 1080 of a computer 1000 achieving the information processing apparatus 10 according to the present example embodiment further stores a program module achieving the function of the determination unit 160.

Next, an advantageous effect of the present example embodiment will be described. In the present example embodiment, an advantageous effect similar to at least any of the first to fifth example embodiments is acquired. In addition, in the information processing apparatus 10 according to the present example embodiment, the determination unit 160 determines the reference value ε, based on accuracy required by the authentication unit 20 that performs authentication by using estimated feature information output from the detection model 132. Accordingly, the detection model 132 with appropriate detection accuracy is acquired according to a purpose of using the detection model 132.

### Seventh Example Embodiment

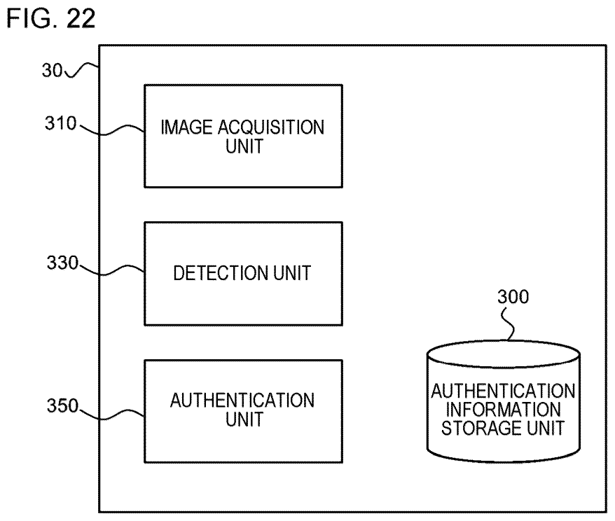

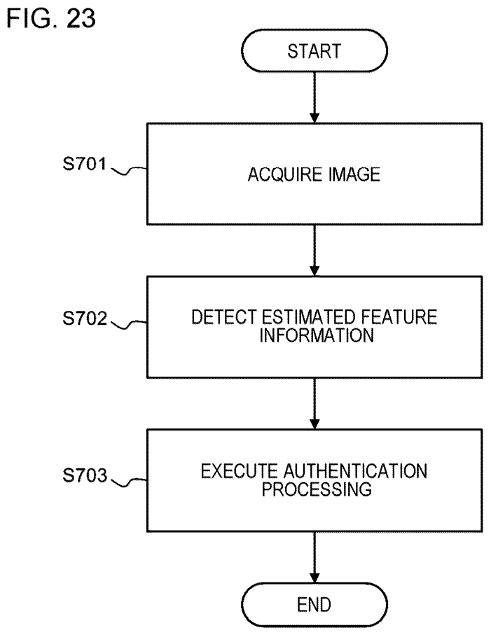

FIG. 22 is a diagram illustrating a function configuration of an authentication apparatus 30 according to a seventh example embodiment. FIG. 23 is a flowchart illustrating a flow of processing performed by the authentication apparatus 30 according to the present example embodiment. The authentication apparatus 30 according to the present example embodiment is an authentication apparatus that uses a detection model 132 of which learning has been performed by using the information processing apparatus 10 according to any of the first to sixth example embodiments and the modified examples 1 and 2. Further, an authentication method according to the present example embodiment is an authentication method using the detection model 132 of which learning has been performed by using the information processing method according to any of the first to sixth example embodiments and the modified examples 1 and 2.

The authentication apparatus 30 according to the present example embodiment includes an image acquisition unit 310, a detection unit 330, and an authentication unit 350. The authentication method according to the present example embodiment can be executed by the authentication apparatus 30 according to the present example embodiment.

In Step S701, the image acquisition unit 310 acquires an image for use in authentication. The image for use in authentication is an image similar to the target image 90 described in the first example embodiment. The image acquisition unit 310 may acquire the image for use in authentication from an image capture apparatus such as a camera, or may read and acquire an image held in a storage apparatus accessible from the image acquisition unit 310.

Then, in Step S702, the detection unit 330 detects estimated feature information in the image acquired by the image acquisition unit 310. Specifically, the detection unit 330 inputs the image (input image) acquired by the image acquisition unit 310 to the detection model 132. The detection model 132 used herein is a learned model by the information processing apparatus 10. The detection unit 330 acquires estimated feature information on the input image as an output of the detection model 132.

Next, in Step S703, the authentication unit 350 performs authentication processing by using the estimated feature information and authentication information held in an authentication information storage unit 300. Specifically, the authentication unit 350 extracts estimated target feature information indicating a feature of a detection target by using the estimated feature information. The authentication unit 350 can extract the estimated target feature information by using the extraction model as described in the fourth example embodiment. The extraction model for use by the authentication unit 350 may be an extraction model used in learning of the detection model 132 for use by the detection unit 330, or may be a model different from the extraction model used in learning of the detection model 132 for use by the detection unit 330.

The authentication information storage unit 300 accessible from the authentication unit 350 holds, as authentication information, a plurality of sets of identification information (for example, personal identification information) and target feature information. The authentication information storage unit 300 may be included in the authentication apparatus 30, or may be provided outside the authentication apparatus 30. The authentication unit 350 computes a degree of agreement between the estimated target feature information extracted by the detection unit 330 and each piece of the target feature information held in the authentication information storage unit 300. Then, the authentication unit 350 specifies target feature information for which the degree of agreement satisfies a predetermined condition, and specifies identification information relevant to the specified target feature information, that is, identification information included in the same set as the specified target feature information.

The authentication apparatus 30 outputs an authentication result. The authentication result output by the authentication apparatus 30 may be the identification information specified by the authentication unit 350, or may be information indicating presence/absence of the target feature information for which the degree of agreement satisfies the predetermined condition.

The authentication result may be displayed, for example, on a display connected to the authentication apparatus 30, or may be output to another apparatus.

An example of a case where the authentication apparatus 30 performs iris recognition will be described below. The image acquisition unit 310 acquires an image including an eye as an image for use in authentication. Then, by inputting the image to the detection model 132, the detection unit 330 acquires estimated feature information for determining an iris area in the image, as illustrated in FIG. 4.

Then, the authentication unit 350 cuts out an iris image from the image including an eye by using the estimated feature information output from the detection unit 330. Then, the authentication unit 350 inputs the iris image to an extraction model, and acquires iris information (estimated target feature information) indicating a feature of an iris as an output of the extraction model.

The authentication information storage unit 300 holds a plurality of sets of personal identification information and iris information in advance. The authentication unit 350 computes a degree of agreement between the iris information extracted by the detection unit 330 and each piece of the iris information held in the authentication information storage unit 300.

Then, the authentication unit 350 specifies iris information for which the degree of agreement satisfies a predetermined condition, and specifies personal identification information relevant to the specified iris information in the authentication information.

The authentication apparatus 30 may output the specified personal identification information, or may output information indicating presence/absence of the authenticated personal identification information.

Note that, the information processing apparatus 10 according to the present example embodiment preferably includes a determination unit 160. Then, a reference value ε for use in the information processing apparatus 10 according to the present example embodiment is preferably determined as described in the sixth example embodiment, based on detection accuracy required by the authentication unit 350.

A hardware configuration of a computer achieving the authentication apparatus 30 according to the present example embodiment is represented by, for example, FIG. 9, similarly to the information processing apparatus 10. However, a storage device 1080 of a computer 1000 achieving the authentication apparatus 30 according to the present example embodiment stores program modules achieving the function configuration units (the image acquisition unit 310, the detection unit 330, and the authentication unit 350) of the authentication apparatus 30.

In a case where the authentication apparatus 30 includes the authentication information storage unit 300, the authentication information storage unit 300 is achieved by the storage device 1080 of the computer 1000 achieving the authentication apparatus 30 according to the present example embodiment.

Next, an advantageous effect of the present example embodiment will be described. According to the authentication apparatus 30 according to the present example embodiment, authentication is performed by using the detection model 132 of which learning has been performed by using the information processing apparatus 10 according to any of the first to sixth example embodiments and the modified examples 1 and 2. Accordingly, highly accurate authentication can be performed.

While the example embodiments and the modified examples of the disclosure have been described above with reference to the drawings, the example embodiments and the modified examples are exemplifications of the disclosure, and various configurations other than the above can be employed.

Further, while a plurality of processes (pieces of processing) are described in order in the plurality of flowcharts used in the above description, execution order of processes executed in each example embodiment and each modified example is not limited to the described order. The order of the illustrated processes can be changed in each example embodiment and each modified example, as long as the change does not detract from contents. Further, the above example embodiments and modified examples can be combined, as long as contents do not contradict each other.

The whole or part of the above-described example embodiments can be described as, but not limited to, the following supplementary notes.

1-1. An information processing apparatus including:
an acquisition unit that acquires a target image and ground truth feature information;
a detection unit that detects estimated feature information relating to a detection target from the target image by using a detection model; and
a loss computation unit that computes a loss for updating a parameter of the detection model in such a way as to generate a detection model capable of tolerating a deviation of the estimated feature information from the ground truth feature information.

1-2. The information processing apparatus according to supplementary note 1-1, further including
an update unit that updates the parameter of the detection model by using the loss.

1-3. The information processing apparatus according to supplementary note 1-2, wherein
the update unit updates the parameter of the detection model according to an error back-propagation method using the loss.

1-4. The information processing apparatus according to any one of supplementary notes 1-1 to 1-3, wherein
the ground truth feature information includes a ground truth feature vector,
the estimated feature information includes an estimated feature vector, and
the loss computation unit
   computes a distance d based on a normalized distance acquired by normalizing a distance between the ground truth feature vector and the estimated feature vector with a size of the detection target, and
   computes the loss by using the distance d.

1-5. The information processing apparatus according to supplementary note 1-4, wherein
the acquisition unit acquires a plurality of sets of the target image and the ground truth feature information,
the loss computation unit computes the normalized distance for each of the plurality of sets, and
the distance d is a sum or an average of the plurality of the normalized distances.

1-6. The information processing apparatus according to supplementary note 1-4 or 1-5, wherein
the loss computation unit
   computes the loss, based on a first rule, in a case where the distance d is less than a predetermined reference value, and
   computes the loss, based on a second rule different from the first rule, in a case where the distance d is equal to or more than the reference value.

1-7. The information processing apparatus according to supplementary note 1-6, wherein
the loss computation unit
   computes an L2 loss as the loss in a case where the distance d is less than the reference value, and
   computes an L1 loss as the loss in a case where the distance d is equal to or more than the reference value.

1-8. The information processing apparatus according to supplementary note 1-6, wherein
the loss computation unit
   uses a predetermined value as the loss in a case where the distance d is less than the reference value, and
   computes an L1 loss as the loss in a case where the distance d is equal to or more than the reference value.

1-9. The information processing apparatus according to supplementary note 1-6, further including
a feature extraction unit that extracts an estimated target feature vector indicating a feature of the detection target indicated by the estimated feature information, wherein
the acquisition unit further acquires a ground truth target feature vector indicating a feature of the detection target, and
the loss computation unit
   computes the loss by using the estimated target feature vector and the ground truth target feature vector in a case where the distance d is less than the reference value, and
   computes an L1 loss based on the estimated feature vector and the ground truth feature vector as the loss in a case where the distance d is equal to or more than the reference value.

1-10. The information processing apparatus according to supplementary note 1-4 or 1-5, further including
a feature extraction unit that extracts an estimated target feature vector indicating a feature of the detection target indicated by the estimated feature information, wherein
the acquisition unit further acquires a ground truth target feature vector indicating a feature of the detection target,
the loss is represented by a following (equation),

loss=β×(1−g(d−ε))×E₂+g(d−ε)×E₁ (equation)
β is a predetermined weight,
ε is a predetermined reference value,
d is the distance d,
g(d−ε) is a monotonic increasing function with an output of 0 or more but 1 or less,
E₁ is an L1 loss computed based on the ground truth feature vector and the estimated feature vector, and
E₂ is a value computed by using the estimated target feature vector and the ground truth target feature vector.

1-11. The information processing apparatus according to any one of supplementary notes 1-6 to 1-10, wherein
change of the loss with respect to change of the distance d is continuous at the reference

1-12. The information processing apparatus according to any one of supplementary notes 1-6 to 1-11, further including
a determination unit that determines the reference value, based on accuracy required by an authentication unit that performs authentication by using the estimated feature information output from the detection model.

2-1. An information processing method including,
by one or more computers:
   acquiring a target image and ground truth feature information;
   detecting estimated feature information relating to a detection target from the target image by using a detection model; and
   computing a loss for updating a parameter of the detection model in such a way as to generate a detection model capable of tolerating a deviation of the estimated feature information from the ground truth feature information.

2-2. The information processing method according to supplementary note 2-1, further including,
by the one or more computers, updating the parameter of the detection model by using the loss.

2-3. The information processing method according to supplementary note 2-2, wherein
the one or more computers update the parameter of the detection model according to an error back-propagation method using the loss.

2-4. The information processing method according to any one of supplementary notes 2-1 to 2-3, wherein
the ground truth feature information includes a ground truth feature vector,
the estimated feature information includes an estimated feature vector, and
the one or more computers
   compute a distance d based on a normalized distance acquired by normalizing a distance between the ground truth feature vector and the estimated feature vector with a size of the detection target, and
   compute the loss by using the distance d.

2-5. The information processing method according to supplementary note 2-4, wherein
the one or more computers
   acquire a plurality of sets of the target image and the ground truth feature information, and
   compute the normalized distance for each of the plurality of sets, and
the distance d is a sum or an average of the plurality of the normalized distances.

2-6. The information processing method according to supplementary note 2-4 or 2-5, wherein
the one or more computers
   compute the loss, based on a first rule, in a case where the distance d is less than a predetermined reference value, and
   compute the loss, based on a second rule different from the first rule, in a case where the distance d is equal to or more than the reference value.

2-7. The information processing method according to supplementary note 2-6, wherein
the one or more computers
   compute an L2 loss as the loss in a case where the distance d is less than the reference value, and
   compute an L1 loss as the loss in a case where the distance d is equal to or more than the reference value.

2-8. The information processing method according to supplementary note 2-6, wherein
the one or more computers
   use a predetermined value as the loss in a case where the distance d is less than the reference value, and
   compute an L1 loss as the loss in a case where the distance d is equal to or more than the reference value.

2-9. The information processing method according to supplementary note 2-6, further including
extracting, by the one or more computers, an estimated target feature vector indicating a feature of the detection target indicated by the estimated feature information, wherein
the acquisition unit further acquires a ground truth target feature vector indicating a feature of the detection target, and
the one or more computers
   compute the loss by using the estimated target feature vector and the ground truth target feature vector in a case where the distance d is less than the reference value, and
   compute an L1 loss based on the estimated feature vector and the ground truth feature vector as the loss in a case where the distance d is equal to or more than the reference value.

2-10. The information processing method according to supplementary note 2-4 or 2-5, further including
extracting, by the one or more computers, an estimated target feature vector indicating a feature of the detection target indicated by the estimated feature information, and
acquiring, by the one or more computers, a ground truth target feature vector indicating a feature of the detection target, wherein
the loss is represented by a following (equation),

loss=β×(1−g(d−ε))×E₂+g(d−ε)×E₁ (equation)
β is a predetermined weight,
ε is a predetermined reference value,
d is the distance d,
g(d−ε) is a monotonic increasing function with an output of 0 or more but 1 or less,
E₁ is an L1 loss computed based on the ground truth feature vector and the estimated feature vector, and
E₂ is a value computed by using the estimated target feature vector and the ground truth target feature vector.

2-11. The information processing method according to any one of supplementary notes 2-6 to 2-10, wherein
change of the loss with respect to change of the distance d is continuous at the reference value.

2-12. The information processing method according to any one of supplementary notes 2-6 to 2-11, further including
determining, by the one or more computers, the reference value, based on accuracy required by an authentication unit that performs authentication by using the estimated feature information output from the detection model.

3-1. A computer-readable medium storing a program,
the program causing a computer to function as:
   an acquisition unit that acquires a target image and ground truth feature information;
   a detection unit that detects estimated feature information relating to a detection target from the target image by using a detection model; and
   a loss computation unit that computes a loss for updating a parameter of the detection model in such a way as to generate a detection model capable of tolerating a deviation of the estimated feature information from the ground truth feature information.

3-2. The medium according to supplementary note 3-1,
the program further causing the computer to function as an update unit that updates the parameter of the detection model by using the loss.

3-3. The medium according to supplementary note 3-2, wherein
the update unit updates the parameter of the detection model according to an error back-propagation method using the loss.

3-4. The medium according to any one of supplementary notes 3-1 to 3-3, wherein
the ground truth feature information includes a ground truth feature vector,
the estimated feature information includes an estimated feature vector, and
the loss computation unit
   computes a distance d based on a normalized distance acquired by normalizing a distance between the ground truth feature vector and the estimated feature vector with a size of the detection target, and
   computes the loss by using the distance d.

3-5. The medium according to supplementary note 3-4, wherein
the acquisition unit acquires a plurality of sets of the target image and the ground truth feature information,
the loss computation unit computes the normalized distance for each of the plurality of sets, and
the distance d is a sum or an average of the plurality of the normalized distances.

3-6. The medium according to supplementary note 3-4 or 3-5, wherein
the loss computation unit
   computes the loss, based on a first rule, in a case where the distance d is less than a predetermined reference value, and
   computes the loss, based on a second rule different from the first rule, in a case where the distance d is equal to or more than the reference value.

3-7. The medium according to supplementary note 3-6, wherein
the loss computation unit
   computes an L2 loss as the loss in a case where the distance d is less than the reference value, and
   computes an L1 loss as the loss in a case where the distance d is equal to or more than the reference value.

3-8. The medium according to supplementary note 3-6, wherein
the loss computation unit
   uses a predetermined value as the loss in a case where the distance d is less than the reference value, and
   computes an L1 loss as the loss in a case where the distance d is equal to or more than the reference value.

3-9. The medium according to supplementary note 3-6,
the program further causing the computer to function as a feature extraction unit that extracts an estimated target feature vector indicating a feature of the detection target indicated by the estimated feature information, wherein
the acquisition unit further acquires a ground truth target feature vector indicating a feature of the detection target, and
the loss computation unit
   computes the loss by using the estimated target feature vector and the ground truth target feature vector in a case where the distance d is less than the reference value, and
   computes an L1 loss based on the estimated feature vector and the ground truth feature vector as the loss in a case where the distance d is equal to or more than the reference value.

3-10. The medium according to supplementary note 3-4 or 3-5,
the program further causing the computer to function as a feature extraction unit that extracts an estimated target feature vector indicating a feature of the detection target indicated by the estimated feature information, wherein
the acquisition unit further acquires a ground truth target feature vector indicating a feature of the detection target,
the loss is represented by a following (equation),

loss=β×(1−g(d−ε))×E₂+g(d−ε)×E₁ (equation)
β is a predetermined weight,
ε is a predetermined reference value,
d is the distance d,
g(d−ε) is a monotonic increasing function with an output of 0 or more but 1 or less,
E₁ is an L1 loss computed based on the ground truth feature vector and the estimated feature vector, and
E₂ is a value computed by using the estimated target feature vector and the ground truth target feature vector.

3-11. The medium according to any one of supplementary notes 3-6 to 3-10, wherein
change of the loss with respect to change of the distance d is continuous at the reference value.

3-12. The medium according to any one of supplementary notes 3-6 to 3-11,
the program further causing the computer to function as a determination unit that determines the reference value, based on accuracy required by an authentication unit that performs authentication by using the estimated feature information output from the detection model.

4-1. A program causing a computer to function as:
an acquisition unit that acquires a target image and ground truth feature information;
a detection unit that detects estimated feature information relating to a detection target from the target image by using a detection model; and
a loss computation unit that computes a loss for updating a parameter of the detection model in such a way as to generate a detection model capable of tolerating a deviation of the estimated feature information from the ground truth feature information.

4-2. The program according to supplementary note 4-1,
the program further causing the computer to function as an update unit that updates the parameter of the detection model by using the loss.

4-3. The program according to supplementary note 4-2, wherein
the update unit updates the parameter of the detection model according to an error back-propagation method using the loss.

4-4. The program according to any one of supplementary notes 4-1 to 4-3, wherein
the ground truth feature information includes a ground truth feature vector,
the estimated feature information includes an estimated feature vector, and
the loss computation unit
   computes a distance d based on a normalized distance acquired by normalizing a distance between the ground truth feature vector and the estimated feature vector with a size of the detection target, and
   computes the loss by using the distance d.

4-5. The program according to supplementary note 4-4, wherein
the acquisition unit acquires a plurality of sets of the target image and the ground truth feature information,
the loss computation unit computes the normalized distance for each of the plurality of sets, and
the distance d is a sum or an average of the plurality of the normalized distances.

4-6. The program according to supplementary note 4-4 or 4-5, wherein
the loss computation unit
   computes the loss, based on a first rule, in a case where the distance d is less than a predetermined reference value, and
   computes the loss, based on a second rule different from the first rule, in a case where the distance d is equal to or more than the reference value.

4-7. The program according to supplementary note 4-6, wherein
the loss computation unit
   computes an L2 loss as the loss in a case where the distance d is less than the reference value, and
   computes an L1 loss as the loss in a case where the distance d is equal to or more than the reference value.

4-8. The program according to supplementary note 4-6, wherein
the loss computation unit
   uses a predetermined value as the loss in a case where the distance d is less than the reference value, and
   computes an L1 loss as the loss in a case where the distance d is equal to or more than the reference value.

4-9. The program according to supplementary note 4-6,
the program further causing the computer to function as a feature extraction unit that extracts an estimated target feature vector indicating a feature of the detection target indicated by the estimated feature information, wherein
the acquisition unit further acquires a ground truth target feature vector indicating a feature of the detection target, and
the loss computation unit
   computes the loss by using the estimated target feature vector and the ground truth target feature vector in a case where the distance d is less than the reference value, and
   computes an L1 loss based on the estimated feature vector and the ground truth feature vector as the loss in a case where the distance d is equal to or more than the reference value.

4-10. The program according to supplementary note 4-4 or 4-5,
the program further causing the computer to function as a feature extraction unit that extracts an estimated target feature vector indicating a feature of the detection target indicated by the estimated feature information, wherein
the acquisition unit further acquires a ground truth target feature vector indicating a feature of the detection target,
the loss is represented by a following (equation),

loss=β×(1 −g(d−ε))×E₂+g(d−ε)×E₁ (equation)
β is a predetermined weight,
ε is a predetermined reference value,
d is the distance d,
g(d−ε) is a monotonic increasing function with an output of 0 or more but 1 or less,
E₁ is an L1 loss computed based on the ground truth feature vector and the estimated feature vector, and
E₂ is a value computed by using the estimated target feature vector and the ground truth target feature vector.

4-11. The program according to any one of supplementary notes 4-6 to 4-10, wherein
change of the loss with respect to change of the distance d is continuous at the reference value.

4-12. The program according to any one of supplementary notes 4-6 to 4-11,
the program further causing the computer to function as a determination unit that determines the reference value, based on accuracy required by an authentication unit that performs authentication by using the estimated feature information output from the detection model.

### REFERENCE SIGNS LIST

10 Information processing apparatus
20 Authentication unit
30 Authentication apparatus
110 Acquisition unit
130, 330 Detection unit
132 Detection model
140, 240 Feature extraction unit
150 Loss computation unit
160 Determination unit
170 Update unit
200 Authentication information storage unit
210 Collation unit
300 Authentication information storage unit
310 Image acquisition unit
350 Authentication unit
1000 Computer
1020 Bus
1040 Processor
1060 Memory
1080 Storage device
1100 Input/output interface
1120 Network interface

What is claimed is:

1. An information processing apparatus comprising:
at least one memory storing instructions; and
at least one processor configured to execute the instructions to perform operations comprising:
acquiring a target image and ground truth feature information;
detecting estimated feature information relating to the target image based on a detection model; and
updating a parameter of the detection model based on a loss having tolerable distance between the estimated feature information and the ground truth feature information.

2. (canceled)

3. The information processing apparatus according to claim 1, wherein
updating the parameter comprises updating the parameter of the detection model according to an error back-propagation method based on the loss having tolerable distance between the estimated feature information and the ground truth feature information.

4. The information processing apparatus according to claim 1, wherein
the operations further comprise determining the loss,
the ground truth feature information includes a ground truth feature vector,
the estimated feature information includes an estimated feature vector, and
determining the loss comprises
determining a normalized distance based on a size of a target;
determining a distance between the estimated feature vector and the ground truth feature vector based on the normalized distance, and
calculating the loss based on the distance.

5. The information processing apparatus according to claim 4, wherein
acquiring the target image and the correct feature information comprises acquiring a plurality of sets of the target image and the ground truth feature information,
determining the loss comprises determining the normalized distance for each of the plurality of sets, and
wherein the distance d is a sum or an average of the plurality of the normalized distances.

6. The information processing apparatus according to claim 4, wherein
the loss is determined based on a first rule, in a case where the distance is less than a predetermined value, and
the loss is determined based on a second rule different from the first rule, in a case where the distance is more than the predetermined value.

7. The information processing apparatus according to claim 6, wherein
the loss is determined as an L2 loss in a case where the distance is less than the predetermined value, and
the loss is determined as an L1 loss in a case where the distance is more than the predetermined value.

8. The information processing apparatus according to claim 6, wherein
the loss is determined as a predetermined threshold value in a case where the distance is less than the predetermined value, and
the loss is determined as an L1 loss in a case where the distance is more than the predetermined value.

9. The information processing apparatus according to claim 6, wherein
the operations further comprise
extracting an estimated target feature vector indicating a feature of the target indicated by the estimated feature information, and
acquiring a ground truth target feature vector indicating a feature of the target, and
determining the loss based on the estimated target feature vector and the ground truth target feature vector in a case where the distance is less than the predetermined value, and
determining the loss as an L1 loss based on the estimated feature vector and the ground truth feature vector in a case where the distance is more than the predetermined value.

10. The information processing apparatus according to claim 4, wherein
the loss is represented by
β×(1 −g(d−ε))×E₂+g(d−ε)×E₁ (equation)
β is a predetermined weight,
ε is a predetermined reference value,
d is the distance d,
g(d−ε) is a monotonic increasing function with an output of 0 or more but 1 or less,
E₁ is an L1 loss determined based on the ground truth feature vector and the estimated feature vector, and
E₂ is a value determined based on an estimated target feature vector and a ground truth target feature vector.

11. The information processing apparatus according to claim 6, wherein
a change of the loss with respect to a change of the distance is continuous at the predetermined value.

12. The information processing apparatus according to claim 6, wherein
the operations further comprise determining the predetermined value based on an authentication accuracy based on the estimated feature information.

13. An information processing method comprising,
by one or more computers:
acquiring a target image and ground truth feature information;
detecting estimated feature information relating to the target image based on a detection model; and
updating a parameter of the detection model based on a loss having tolerable distance between the estimated feature information and the ground truth feature information.

14. A non-transitory computer-readable medium storing a program, causing a computer to execute a control method, the control method comprising:
acquiring a target image and ground truth feature information;
detecting estimated feature information relating to the target image based on a detection model; and
updating a parameter of the detection model based on a loss having tolerable distance between the estimated feature information and the ground truth feature information.
